(19) United States
(12) Patent Application Publication
(10) Pub. No.: US 2006/0112645 A1
(43) Pub. Date: Jun. 1, 2006

(54) Door or window seal for an automobile for reducing transmission of low-frequency noises to the interior of the automobile

(75) Inventor: Bernard Dron, Puteaux (FR)

Correspondence Address: Stephen B. Salai, Esq.;Harter, Secrest & Emery LLP, 1600 Bausch & Lomb Place, Rochester, NY, 14604-2711, US

(73) Assignee: Metzeler Automotive Profile Systems Transieres, Nanterre (FR)

(21) Appl. No.: 10/998,504

(22) Filed: Nov. 29, 2004

(51) Int. Cl. E06B 7/16

(52) U.S. Cl. 49/498.1; 49/490.1

(57) ABSTRACT

According to the invention, in order to vary the pressure exerted by this seal on the door or window and on the related frame, in order to thereby reduce the transmission of low-frequency chassis noises into the interior of the car, the tubular portion (8) of this seal has at least one wall whose thickness varies along the length of the seal.

This invention relates to door or window seals for automobiles. More specifically, its objective is a door or window seal for reducing low-frequency noises, similar to humming noises, that are produced by the chassis when it moves and that are transmitted to the interior of the car.

The influence of the door or window seals on the acoustic transparency of automobiles, i.e., on the difference between the outside noise produced by a car moving on the pavement and the noise heard inside the car, is well known in the relevant research.

By contrast, it appears that no studies have been conducted regarding the effects of these same seals on the transmission of vibrations from the automobile chassis components between which the seals are inserted.

These seals generally include a portion having a tubular shape whose section and thickness are constant over their entire length and which, as a result, rests with a roughly equal force on the portions of the car between which it is compressed, e.g., on the door of the car and the associated door frame, or on the window and the associated window frame, regardless of the area of the door or window frame in question. Most of these seals, have, in cross-section, a thickness which may vary considerably, and numerous seals of this type have been proposed in the relevant research. On the other hand, the variations in thickness of these tubular seals along their length have not been systematically studied.

However, the studies carried out by the Applicant have shown that the low-frequency chassis noises, i.e., less than 500 Hz, that are transferred into the interior of the car and that sound like humming to the passengers, have an intensity that varies quite perceptibly depending on the sections of the chassis against which the seals conventionally rest. These variations in intensity between the various sections of a doorframe may in practice, within the low-frequency range, span 3 decibels or even 4 decibels, at a given frequency.

In continuing his research on the phenomenon, the Applicant determined that it is possible to eliminate this drawback and to considerably diminish the humming resulting from the transmission of low-frequency chassis noises into the interior of the car by locally varying the pressure exerted by the tubular portion of the seal along its length, based on the position that the various portions of this seal occupy on the door frame.

As a result, the purpose of the invention is a seal for the door or window frame of a car, said seal normally being produced by means of extrusion and containing at least two adjacent tubular portions which are to be inserted between the frame and the related door or window, with one section integral with a part of the seal having a U-shaped transversal section designed to cap a protruding part of the frame; said seal is characterized in that, in order to vary the pressure exerted by this seal along its length on the door or window and on the related frame, so as to thereby reduce the transmission to the interior of the car of these low-frequency chassis noises, the tubular portion adjacent to the portion that has a U-shaped section contains at least one wall whose thickness varies, but without marked discontinuities, along the length of the seal.

From U.S. Pat. No. 4,619,077, we know of a seal containing a fixed part to which a tubular portion is adjacent, with this seal consisting of first and second sections that are basically rectilinear and connected to angular parts with small radii of curvature, and this seal is characterized in that the wall of the tubular portion of the second sections is greater in thickness than the wall of the tubular portion of the first sections, with the increase in the thickness being realized during the extrusion of the seal.

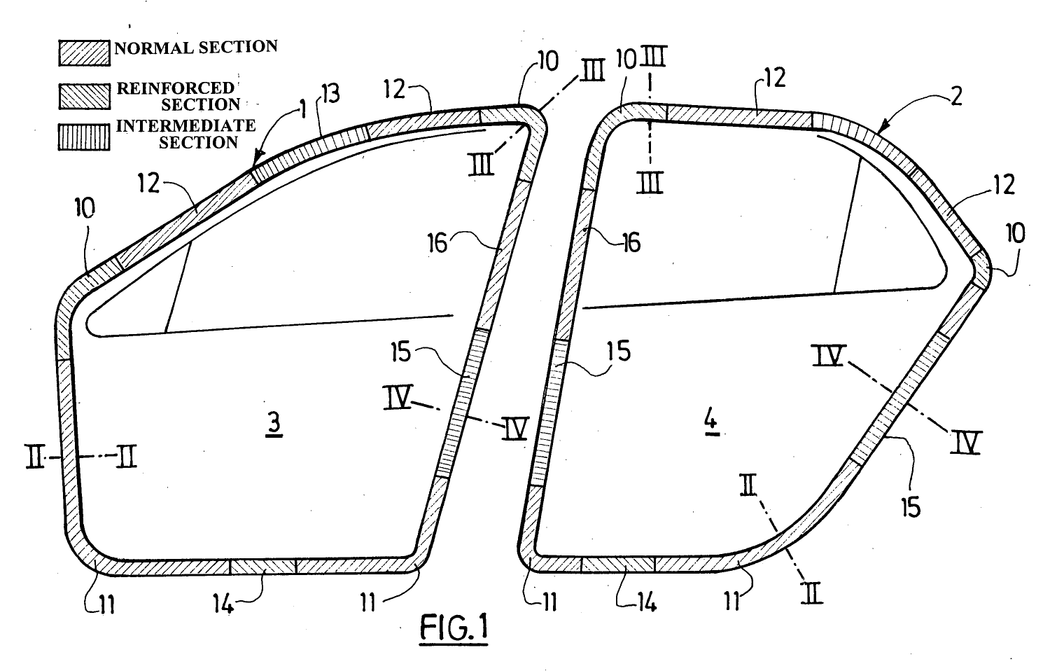

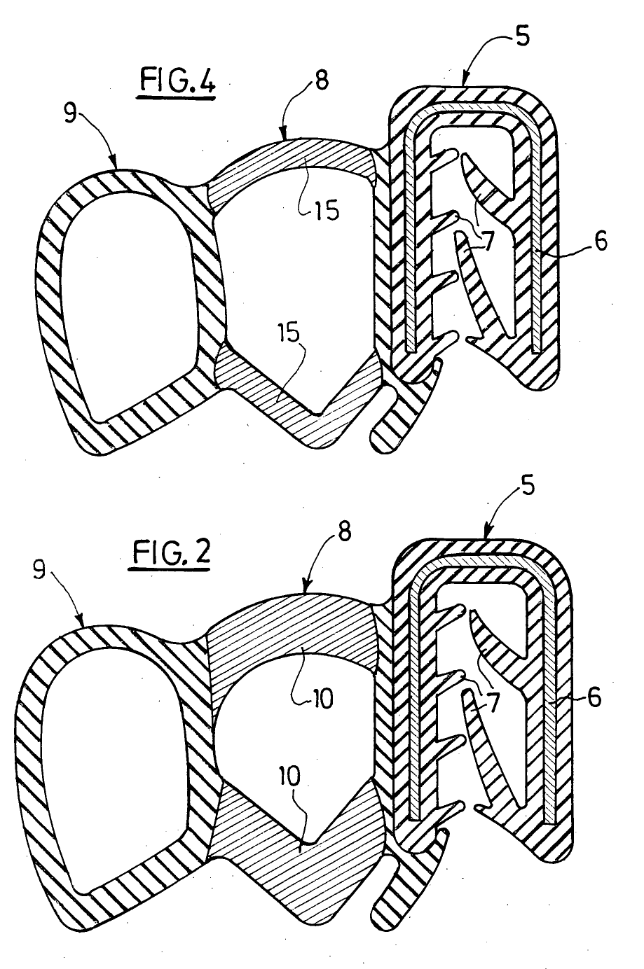

If, however, we refer to the description of this patent, we observe that there is no continuous variation in the thickness of the wall, but that this thickness changes abruptly between the various parts of the seal and then remains constant along the length of these parts (see FIGS. 2, 3, and 4, which are cross-sectional views along lines II-II, III-III, and IV-IV respectively of FIG. 1). More precisely, the tubular portion has a wall whose thickness is greater than that of the curved parts, so that it does not bend as much within the opening comers with which it is associated.

The seal in conformity with the invention also has another purpose.

In effect, as is well known in the relevant research, the pressure exerted by these door and window seals on the panels and the frames can be easily determined, in order to locally modify this pressure by adapting the section and thickness of the seal so that it can be reduced or increased accordingly with appropriate precision. In conformity with the invention, it is therefore possible to locally modify the pressure exerted by the seal, the means by which the car chassis and doors vibrate, and the transmission of these vibrations into the interior of the car.

For example, with a door frame seal that contains a tubular portion:
the portions of the tubular part adjacent to the comers on the upper part of the door will preferably be greater in thickness than the tubular part of a normal seal of the same type; in the middle area between these two comers, this thickness will decrease to a value preferably lower than that of the tubular portion of a normal seal;
within the two comers on the lower part of the door, the thickness of the tubular portion of the seal will preferably be roughly equal to that of the tubular portion of a normal seal of the same type, but it will increase in the middle area between these two comers to a thickness that is greater than the thickness of the tubular portion of a normal seal;
finally, between the door's two upper comers and two lower comers, as far as a middle area between them, the thickness of the tubular portion of the seal shall decrease as appropriate to that of the tubular portion of a normal seal or a lesser thickness.

In the case of a seal that contains two adjacent tubular portions, one of which is integral with a part having a clamp-forming U-shaped transversal section and designed to cap a protruding part of a panel or a frame of this panel, the dimensions of the tubular portion adjacent to the clamp-forming part and, more specifically, what are called the “legs” of this tubular portion, i.e., the parts of the latter that are integral with the clamp- forming part and the second tubular portion, will preferably be modified.

It is this form of implementing the invention that will be described below in detail, by way of non-restrictive example, but obviously the invention is not limited to the door seals of automobiles and may also be applied to seals for the lateral windows of these automobiles, for use in controlling this type of vibration by considerably improving the acoustic transparency, particularly for frequencies in the range of 3 kHz.

As indicated above, one form of implementing the invention will now be described in greater detail. This version uses car door seals of the “twin-tube” type, i.e., comprising two tubular parts that are laterally adjacent along their length, and a section that forms a U-shaped clamp, of which one leg forms an integral part with one of these tubular parts.

In this description, the attached drawings shall be referred to, in which:

FIG. 1 is a schematic drawing of two seals according to the invention, in the position that they occupy when they are fitted to the frame of a front door and rear door respectively of a car;

FIGS. 2, 3 and 4 are transversal cross-sections of these seals, along lines II-II, III-III, and IV-IV respectively of FIG. 1.

As can be seen on the drawings, the door seals 1 and 2 of this version, fitted to a front door 3 and a rear door 4 respectively of a car and simply outlined on FIG. 1, include in known fashion:
a part 5 with a U-shaped section, designed to cap a protruding part of a door frame by clamping it; this part 5, which may be an elastomer or plastomer, may include a U-shaped reinforcement 6 and have lips 7on the internal sides of its legs, designed to prevent the cap from inadvertently loosening itself from the protruding part that it caps;
a first tubular section 8, made of a thermoplastic or elastomer material that can bend elastically, which is integral along its entire length with a leg of the clamp-forming section 1;
a second tubular section 9, which is also made of a thermoplastic or elastomer material that can bend elastically, and which is adjacent to section 8 along its entire length, on the opposite side of the clamp 1.

The clamp 1 and the sections 8 and 9 are preferably manufactured by means of extrusion.

The 2 seals 1 and 2 shown on FIG. 1 are in principle the same.

In conformity with the invention, at least one of the tubular sections, in this case the middle section 8, has a wall thickness that varies according to the position it occupies on the door frame and which is adapted to the desired means of vibration of the door frame and the door itself, so as to reduce or even eliminate the muffled humming noise transmitted in the low frequencies into the car's interior.

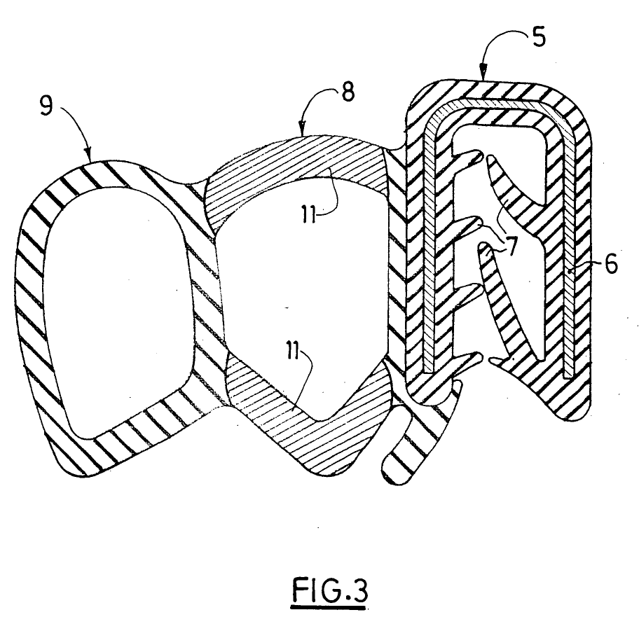

With this objective, as shown on the drawings, the portions 10 of the tubular parts 8 located in the upper corners of doors 3 and 4 (see FIG. 2) have a thickness greater than that of the corresponding part of a seal of the same type that is uniform in thickness along its entire length, whereas the same parts of the tubular portions 8 situated in the lower angles, indicated as 11, have a thickness that is roughly the same as that of the same part of normal seals (see FIG. 3).

Between the parts 10 of the seals 1 and 2 situated in the upper comers of the door frame, the thickness of the tubular portion 8 decreases to a value roughly equal to that of a normal seal in the adjacent sections indicated by the number 12, and decreases even further in the intermediate section 13 between the sections 12.

Between the sections 11 of seals 1 and 2 situated in the lower comers of the door frame, on the contrary, the tubular portion 8 is reinforced in 14 by increasing its thickness.

Finally, moving from the upper comers of the door frames to the lower comers, the thickness of the tubular portion 8 of the seals decreases to that of a normal seal for the front part of the door frame and decreases still further, to a thickness below that of a normal seal, at 15 near the sections 11. These sections 15 then connect to the adjacent sections 10 via sections 16 that are equal in thickness to a normal seal.

Of course, the invention also applies to door or window seals that include a single tubular portion or even, especially for windows, a single lip.

As has been indicated above, the optimal variations of thickness can be calculated from vibration measurements, preferably on a chassis dynamometer, and the production of seals in accordance with the intention will thus not pose any problems for specialists in the relevant technology.

1. Seal for a door or window frame of a car, said seal normally being produced by means of extrusion and containing at least two adjacent tubular portions (8, 9) to be inserted between the frame and the related door or window, with one (8) of these portions integral with a portion (5) of the seal having a U- shaped transversal section and designed to cap a protruding part of the frame, said seal being characterized in that, in order to vary the pressure exerted by this seal along its length on the door or window and on the associated frame, so as to thereby reduce the transmission of the low-frequency chassis noises into the interior of the car, the tubular section 8 adjacent to the portion 5 that has a U-shaped transversal section contains at least one wall whose thickness varies, but without marked discontinuities, along the length of the seal.

2. Seal according to claim 1, in which the tubular portion (8) adjacent to the clamp-forming section (5) is defined by the sections called “legs” joining the clamp-forming part and the second tubular portion (9), characterized in that the thickness of the legs (10, 11, 15) varies along the length of the seal.

3. Seal according to claim 1, characterized in that:
the portions (12) of the tubular part (8) that are adjacent to the corners on the upper part of the door are greater in thickness than the tubular part of a normal seal of the same type; in the middle area between these two corners, this thickness will decrease to a value preferably lower than that of the tubular portion of a normal seal;
within the two corners on the lower part of the door, the thickness of the tubular portion of the seal (at 11) is roughly equal to that of the tubular portion of a normal seal of this type, but it will increase in the middle area between these two corners (at 14) to a thickness that is greater than the thickness of the tubular portion of a normal seal;
finally, between the door's two upper corners and two lower corners, as far as the middle area between them, the thickness of the tubular portion of the seal decreases as appropriate to that of the tubular portion of a normal seal (at 16) or a lesser thickness (at 15).

4. Seal according to claim 2, characterized in that:
the portions (12) of the tubular part (8) that are adjacent to the corners on the upper part of the door are greater in thickness than the tubular part of a normal seal of the same type; in the middle area between these two corners, this thickness will decrease to a value preferably lower than that of the tubular portion of a normal seal;
within the two corners on the lower part of the door, the thickness of the tubular portion of the seal (at 11) is roughly equal to that of the tubular portion of a normal seal of this type, but it will increase in the middle area between these two corners (at 14) to a thickness that is greater than the thickness of the tubular portion of a normal seal;
finally, between the door's two upper corners and two lower corners, as far as the middle area between them, the thickness of the tubular portion of the seal decreases as appropriate to that of the tubular portion of a normal seal (at 16) or a lesser thickness (at 15).
